(19) United States
(12) Patent Application Publication
(10) Pub. No.: US 2020/0236994 A1
(43) Pub. Date: Jul. 30, 2020

(54) ARTICLE FOR USE WITH APPARATUS FOR HEATING SMOKABLE MATERIAL

(71) Applicant: BRITISH AMERICAN TOBACCO (INVESTMENTS) LIMITED, London (GB)

(72) Inventors: Thomas P. BLANDINO, Cottage Grove, WI (US); Andrew WILKE, Madison, WI (US); James J. FRATER, Madison, WI (US); Benjamin J. PAPROCKI, Cottage Grove, WI (US)

(21) Appl. No.: 16/852,010

(22) Filed: Apr. 17, 2020

Related U.S. Application Data
(63) Continuation of application No. 15/754,812, filed on Feb. 23, 2018.
Application No. 15/754,812 is a continuation of application No. 14/840,731, filed on Aug. 31, 2015, now abandoned.

(51) Int. Cl. A24F 40/20; H05B 6/10; H05B 1/02

(52) U.S. Cl. CPC A24F 40/20; H05B 1/0291; H05B 6/105

(57) ABSTRACT

Disclosed is an article for use with apparatus for heating smokable material to volatilize at least one component of the smokable material. The article includes a mass of smokable material and an elongate member within the mass of smokable material. The elongate member includes heating material that is heatable by penetration with a varying magnetic field. Also disclosed is a method of manufacturing such an article. The method includes providing an elongate element comprising heating material that is heatable by penetration with a varying magnetic field, and locating the elongate element within smokable material. The providing and the locating may form an elongate assembly including the elongate element within the smokable material, and the method may include cutting the elongate assembly at a predetermined longitudinal position along the elongate assembly to form the article.

### PRIORITY CLAIM

This application is a continuation of application Ser. No. 15/754,812 filed Feb. 23, 2018, which in turn is a National Phase entry of PCT Application No. PCT/EP2016/070182, filed Aug. 26, 2016, which claims priority from U.S. patent application Ser. No. 14/480,731, filed Aug. 31, 2015, each of which is hereby fully incorporated herein by reference.

### TECHNICAL FIELD

The present disclosure relates to articles for use with apparatus for heating smokable material to volatilize at least one component of the smokable material, to methods of manufacturing such articles, and to systems comprising such articles and apparatuses.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

### SUMMARY

A first aspect of the present disclosure provides an article for use with apparatus configured to heat smokable material to volatilize at least one component of the smokable material, the article comprising: a mass of smokable material; and an elongate member within the mass of smokable material, wherein the elongate member comprises heater or heating material that is heatable by penetration with a varying magnetic field.

In an exemplary embodiment, the elongate member extends to opposite longitudinal ends of the mass of smokable material.

In an exemplary embodiment, the elongate member is encircled by the mass of smokable material. In an exemplary embodiment, the elongate member is surrounded by the mass of smokable material.

In an exemplary embodiment, the elongate member is impermeable to air or volatilized material, or substantially free of discontinuities. In another exemplary embodiment, the elongate member is permeable to air and/or permeable to volatilized material.

In an exemplary embodiment, the elongate member consists entirely, or substantially entirely, of the heating material.

In respective exemplary embodiments, the heater or heating material comprises one or more materials selected from the group consisting of: an electrically-conductive material, a magnetic material, and a non-magnetic material. In respective exemplary embodiments, the heating material comprises a metal, a metal alloy. In respective exemplary embodiments, the heating material comprises one or more materials selected from the group consisting of: aluminum, gold, iron, nickel, cobalt, conductive carbon, graphite, plain-carbon steel, stainless steel, ferritic stainless steel, copper, and bronze.

In an exemplary embodiment, the heating material is in contact with the smokable material.

In an exemplary embodiment, the article comprises a thermally-conductive barrier that spaces the elongate member from the smokable material. In some embodiments, the thermally-conductive barrier may be a thermally-conductive coating on the elongate member.

In an exemplary embodiment, the elongate member has two opposing major surfaces joined by two minor surfaces. In an exemplary embodiment, the elongate member has a length and a cross-section perpendicular to the length, wherein the cross-section has a width and a depth, and wherein the length is greater than the width, and the width is greater than the depth.

In an exemplary embodiment, the elongate member is substantially planar. In some embodiments, the elongate member may be a flat strip or ribbon. In another exemplary embodiment, the elongate member is non-planar. In respective exemplary embodiments, the elongate member has at least one curved major surface, is twisted, or is corrugated.

In an exemplary embodiment, a first portion of the elongate member is more susceptible to eddy currents being induced therein by penetration with a varying magnetic field than a second portion of the elongate member. In some embodiments, the first portion of the elongate member is made of a first material, the second portion of the elongate member is made of a different second material, and the first material is of a higher susceptibility than the second material. In some embodiments, the first portion of the elongate member may have a different thickness to the second portion of the elongate member.

In an exemplary embodiment, the article comprises a catalytic material on at least a portion of the elongate member.

In an exemplary embodiment, the article is elongate, and the elongate member extends along a longitudinal axis that is substantially aligned to a longitudinal axis of the article. Such aligned axes may be parallel to each other or coincident with each other.

In an exemplary embodiment, the article comprises a mouthpiece defining a passageway that is in fluid communication with the mass of smokable material.

In an exemplary embodiment, the article comprises a cover around the mass of smokable material and the elongate member. In an exemplary embodiment, the cover comprises heating material that is heatable by penetration with a varying magnetic field. In some embodiments, the cover comprises a wrapper. In some embodiments, the wrapper comprises a sheet of paper. In some embodiments, the cover comprises a mass of thermal insulation. In some embodiments, the elongate member is kept out of contact with the cover.

In an exemplary embodiment, the article is elongate and has a circular cross-section.

In an exemplary embodiment, the smokable material comprises tobacco and/or one or more humectants.

In an exemplary embodiment, the article comprises a temperature detector for detecting a temperature of the article. In some embodiments, the article comprises one or more terminals connected to the temperature detector for making connection with a temperature monitor of the apparatus in use.

A second aspect of the present disclosure provides a method of manufacturing an article for use with apparatus for heating smokable material to volatilize at least one component of the smokable material, the method comprising: providing an elongate element comprising heating material that is heatable by penetration with a varying magnetic field; and locating the elongate element within smokable material.

In an exemplary embodiment, the locating comprises moving the smokable material along a path, and feeding the elongate element into the smokable material as the smokable material moves along the path, so as to entrain the elongate element in the smokable material.

In an exemplary embodiment, the providing and the locating forms an elongate assembly comprising the elongate element within the smokable material, and the method comprises cutting the elongate assembly at a predetermined longitudinal position along the elongate assembly to form the article.

In respective exemplary embodiments, the article may have any of the features of the above-described exemplary embodiments of the article of the first aspect of the present disclosure.

In an exemplary embodiment, the method comprises providing a covering around the smokable material and the elongate element. In some embodiments, the covering comprises a wrapper. In some embodiments, the wrapper comprises a sheet of paper. In some embodiments, the covering comprises a mass of thermal insulation. In some embodiments, the elongate element is kept out of contact with the covering.

In an exemplary embodiment, the providing the covering comprises wrapping a combination of the elongate element and smokable material with the covering as the combination passes through a tongue of a garniture.

A third aspect of the present disclosure provides a system, comprising: apparatus for heating smokable material to volatilize at least one component of the smokable material; and an article for use with the apparatus, wherein the article comprises a mass of smokable material, and an elongate member within the mass of smokable material, wherein the elongate member comprises heating material that is heatable by penetration with a varying magnetic field.

In an exemplary embodiment, the apparatus comprises an interface for cooperating with the article, and a magnetic field generator for generating a varying magnetic field for penetrating the heating material when the article is cooperating with the interface.

In respective exemplary embodiments, the article of the system may have any of the features of the above-described exemplary embodiments of the article of the first aspect of the present disclosure.

### BRIEF DESCRIPTION OF THE DRAWINGS

Embodiments of the disclosure will now be described, by way of example only, with reference to the accompanying drawings, in which:

FIG. 1 shows a schematic perspective view of an example of an article for use with apparatus for heating smokable material to volatilize at least one component of the smokable material.

FIG. 2 shows a schematic cross-sectional view of the article of FIG. 1.

FIG. 3 shows another schematic cross-sectional view of the article of FIG. 1.

FIG. 4 shows a schematic cross-sectional view of an example of another article for use with apparatus for heating smokable material to volatilize at least one component of the smokable material.

FIG. 5 shows a schematic cross-sectional view of an example of another article for use with apparatus for heating smokable material to volatilize at least one component of the smokable material.

FIG. 6 shows a schematic cross-sectional view of an example of another article for use with apparatus for heating smokable material to volatilize at least one component of the smokable material.

FIG. 7 shows a schematic cross-sectional view of an example of another article for use with apparatus for heating smokable material to volatilize at least one component of the smokable material.

FIG. 8 shows a schematic cross-sectional view of an example of another article for use with apparatus for heating smokable material to volatilize at least one component of the smokable material.

FIG. 9 shows a schematic partial cross-sectional view of an example of another article for use with apparatus for heating smokable material to volatilize at least one component of the smokable material.

FIGS. 10(a) to 10(c) show operations of an example of a method of manufacturing an article for use with apparatus for heating smokable material to volatilize at least one component of the smokable material.

### DETAILED DESCRIPTION

As used herein, the term “smokable material” includes materials that provide volatilized components upon heating, typically in the form of vapor or an aerosol.

“Smokable material” may be a non-tobacco-containing material or a tobacco-containing material. “Smokable material” may, for example, include one or more of tobacco per se, tobacco derivatives, expanded tobacco, reconstituted tobacco, tobacco extract, homogenized tobacco or tobacco substitutes. The smokable material can be in the form of ground tobacco, cut rag tobacco, extruded tobacco, liquid, gel, gelled sheet, powder, or agglomerates. “Smokable material” also may include other, non-tobacco, products, which, depending on the product, may or may not contain nicotine. “Smokable material” may comprise one or more humectants, such as glycerol or propylene glycol.

As used herein, the term “heating material” refers to material that is heatable by penetration with a varying magnetic field.

As used herein, the terms “flavor” and “flavorant” refer to materials which, where local regulations permit, may be used to create a desired taste or aroma in a product for adult consumers. They may include extracts (e.g., licorice, hydrangea, Japanese white bark magnolia leaf, chamomile, fenugreek, clove, menthol, Japanese mint, aniseed, cinnamon, herb, wintergreen, cherry, berry, peach, apple, Drambuie, bourbon, scotch, whiskey, spearmint, peppermint, lavender, cardamom, celery, cascarilla, nutmeg, sandalwood, bergamot, geranium, honey essence, rose oil, vanilla, lemon oil, orange oil, cassia, caraway, cognac, jasmine, ylang-ylang, sage, fennel, piment, ginger, anise, coriander, coffee, or a mint oil from any species of the genus Mentha), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, oil, liquid, gel, powder, or the like.

Induction heating is a process in which an electrically-conductive object is heated by penetrating the object with a varying magnetic field. The process is described by Faraday's law of induction and Ohm's law. An induction heater may comprise an electromagnet and a device for passing a varying electrical current, such as an alternating current, through the electromagnet. When the electromagnet and the object to be heated are suitably relatively positioned so that the resultant varying magnetic field produced by the electromagnet penetrates the object, one or more eddy currents are generated inside the object. The object has a resistance to the flow of electrical currents. Therefore, when such eddy currents are generated in the object, their flow against the electrical resistance of the object causes the object to be heated. This process is called Joule, ohmic, or resistive heating. An object that is capable of being inductively heated is known as a susceptor.

It has been found that, when the susceptor is in the form of a closed circuit, magnetic coupling between the susceptor and the electromagnet in use is enhanced, which results in greater or improved Joule heating.

Magnetic hysteresis heating is a process in which an object made of a magnetic material is heated by penetrating the object with a varying magnetic field. A magnetic material can be considered to comprise many atomic-scale magnets, or magnetic dipoles. When a magnetic field penetrates such material, the magnetic dipoles align with the magnetic field. Therefore, when a varying magnetic field, such as an alternating magnetic field, for example as produced by an electromagnet, penetrates the magnetic material, the orientation of the magnetic dipoles changes with the varying applied magnetic field. Such magnetic dipole reorientation causes heat to be generated in the magnetic material.

When an object is both electrically-conductive and magnetic, penetrating the object with a varying magnetic field can cause both Joule heating and magnetic hysteresis heating in the object. Moreover, the use of magnetic material can strengthen the magnetic field, which can intensify the Joule heating.

In each of the above processes, as heat is generated inside the object itself, rather than by an external heat source by heat conduction, a rapid temperature rise in the object and more uniform heat distribution can be achieved, particularly through selection of suitable object material and geometry, and suitable varying magnetic field magnitude and orientation relative to the object. Moreover, as induction heating and magnetic hysteresis heating do not require a physical connection to be provided between the source of the varying magnetic field and the object, material deposits on the object such as smokable material residue may be less of an issue, design freedom and control over the heating profile may be greater, and cost may be lower.

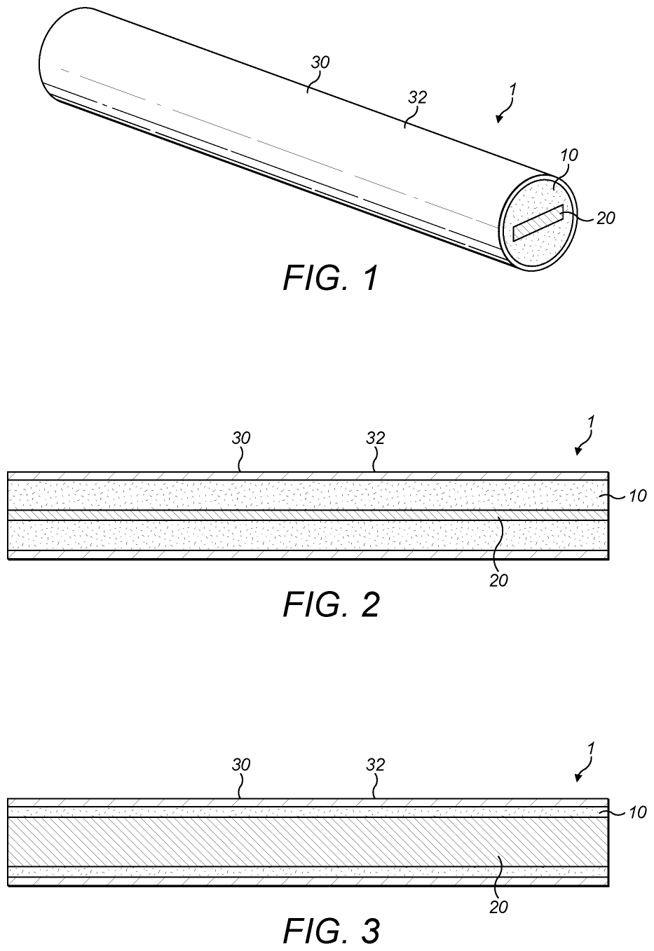

Referring to FIGS. 1, 2 and 3 there are shown a schematic perspective view and two schematic cross-sectional views, taken at ninety degrees to each other, of an example of an article according to an embodiment of the disclosure. The article 1 comprises a mass of smokable material 10, and an elongate member 20 within the mass of smokable material 10. The elongate member 20 comprises heating material that is heatable by penetration with a varying magnetic field. The article 1 also comprises a cover 30 around the mass of smokable material 10 and the elongate member 20. The article 1 is for use with apparatus for heating the smokable material 10 to volatilize at least one component of the smokable material 10 without burning the smokable material 10. An example such apparatus is described below.

In this embodiment, the article 1 is elongate and cylindrical with a substantially circular cross section. However, in other embodiments, the article 1 may have a cross section other than circular and/or not be elongate and/or not be cylindrical. In this embodiment, the article 1 has proportions approximating those of a cigarette.

In this embodiment, the elongate member 20 extends along a longitudinal axis that is substantially aligned with a longitudinal axis of the article 1. This can help to provide more uniform heating of the smokable material 10 in use, and can also aid manufacturing of the article 1, as described by way of example below. In this embodiment, the aligned axes are coincident. In a variation to this embodiment, the aligned axes may be parallel to each other. However, in other embodiments, the axes may be oblique to each other.

In this embodiment, the elongate member 20 extends to opposite longitudinal ends of the mass of smokable material 10. This can help to provide more uniform heating of the smokable material 10 in use, and can also aid manufacturing of the article 1, as described by way of example below. However, in other embodiments, the elongate member 20 may not extend to either of the opposite longitudinal ends of the mass of smokable material 10, or may extend to only one of the longitudinal ends of the mass of smokable material 10 and be spaced from the other of the longitudinal ends of the mass of smokable material 10.

In this embodiment, the elongate member 20 is encircled by the mass of smokable material 10. That is, the smokable material 10 extends around the elongate member 20. In embodiments in which the elongate member 20 does not extend to either of the opposite longitudinal ends of the mass of smokable material 10, the smokable material 10 may extend around the elongate member 20 and also cover the longitudinal ends of the elongate member 20, so that the elongate member 20 is surrounded by the mass of smokable material 10.

In this embodiment, the elongate member 20 is impermeable to air or volatilized material, and is substantially free of discontinuities. The elongate member 20 may thus be relatively easy to manufacture. However, in variations to this embodiment, the elongate member 20 may be permeable to air and/or permeable to volatilized material created when the smokable material 10 is heated. Such a permeable nature of the elongate member 20 may help air passing through the article 1 to pick up the volatilized material created when the smokable material 10 is heated. Such a permeable nature of the elongate member 20 may also act to impede an undesired thermal path to a longitudinal end of the elongate member 20, at which heat could leak from the article without heating the smokable material 10.

In this embodiment, the elongate member 20 consists entirely, or substantially entirely, of the heating material. The heating material may comprise one or more materials selected from the group consisting of: an electrically-conductive material, a magnetic material, and a non-magnetic material. The heating material may comprise a metal or a metal alloy. The heating material may comprise one or more materials selected from the group consisting of: aluminum, gold, iron, nickel, cobalt, conductive carbon, graphite, plain-carbon steel, stainless steel, ferritic stainless steel, copper, and bronze. The elongate member 20 may comprise, for example, resistance wire or ribbon, such as Kanthal® wire or ribbon. Other heating material(s) may be used in other embodiments. It has also been found that, when magnetic electrically-conductive material is used as the heating material, magnetic coupling between the elongate member 20 and an electromagnet of the apparatus in use may be enhanced. In addition to potentially enabling magnetic hysteresis heating, this can result in greater or improved Joule heating of the heating material, and thus greater or improved heating of the smokable material 10.

In this embodiment, the heating material of the elongate member 20 is in contact with the smokable material 10. Thus, when the heating material is heated by penetration with a varying magnetic field, heat may be transferred directly from the heating material to the smokable material 10. In other embodiments, the heating material may be kept out of contact with the smokable material 10. For example, in some embodiments, the article 1 may comprise a thermally-conductive barrier that is free of heating material and that spaces the elongate member 20 from the smokable material 10. In some embodiments, the thermally-conductive barrier may be a coating on the elongate member 20. The provision of such a barrier may be advantageous to help to retain heat in the article 1 after inductive heating of the elongate member 20 has ceased.

In this embodiment, the elongate member 20 has a rectangular, or substantially rectangular, cross section perpendicular to its length. The cross-section has a width and a depth. As best shown by the combination of FIGS. 2 and 3, the length of the elongate member 20 is greater than the width of the cross section, and the width of the cross section is greater than the depth of the cross section. In some embodiments, the elongate member 20 has a length of between thirty and fifty millimeters, such as forty millimeters. In some embodiments, the elongate member 20 has a width of between three and six millimeters, such as 4.5 millimeters. In some embodiments, the elongate member 20 has a depth of less than two millimeters. In some embodiments, the elongate member 20 has a depth of less than one millimeter. In some embodiments, the elongate member 20 has a depth of between 0.1 and 0.6 millimeters, such as 0.3 millimeters.

In this embodiment, the elongate member 20 has two opposing major surfaces joined by two minor surfaces. Therefore, the depth or thickness of the elongate member 20 is relatively small as compared to the other dimensions of the elongate member 20. The heating material may have a skin depth, which is an exterior zone within which most of an induced electrical current and/or induced reorientation of magnetic dipoles occurs. By providing that the heating material has a relatively small thickness, a greater proportion of the heating material may be heatable by a given varying magnetic field, as compared to heating material having a depth or thickness that is relatively large as compared to the other dimensions of the heating material. Thus, a more efficient use of material is achieved and, in turn, costs are reduced. However, in other embodiments, the elongate member 20 may have a cross-section that is a shape other than rectangular, such as circular, elliptical, annular, polygonal, square, triangular, star-shaped, or radially-finned.

In this embodiment, the cross section of the elongate member 20 is constant along the length of the elongate member 20. Moreover, in this embodiment, the elongate member 20 is planar, or substantially planar. The elongate member 20 of this embodiment can be considered a flat strip or ribbon. However, in other embodiments, examples of which are discussed below, this may not be the case.

In this embodiment, the cover 30 defines an outer surface of the article 1, which may contact the apparatus in use. In this embodiment, the cover 30 comprises a wrapper 32 that comprises a sheet of material. In this embodiment, the sheet of material comprises a sheet of paper, but in other embodiments the sheet may be of a material other than paper. In this embodiment, the cover 30 encircles the smokable material 10. In other embodiments, the cover 30 may also cover one or both longitudinal ends of the article. In some embodiments, the wrapper 32 is wrapped around the smokable material 10 so that free ends of the wrapper 32 overlap each other. The wrapper 32 may then also comprise an adhesive that adheres the overlapped free ends of the wrapper 32 to each other to help prevent them from separating. In other embodiments, the adhesive may be omitted. In this embodiment, the elongate member 20 is kept out of contact with the cover 30. This can help avoid singeing of the cover 30 as the elongate member 20 is heated in use. However, in other embodiments, the elongate member 20 may be in contact with the cover 30.

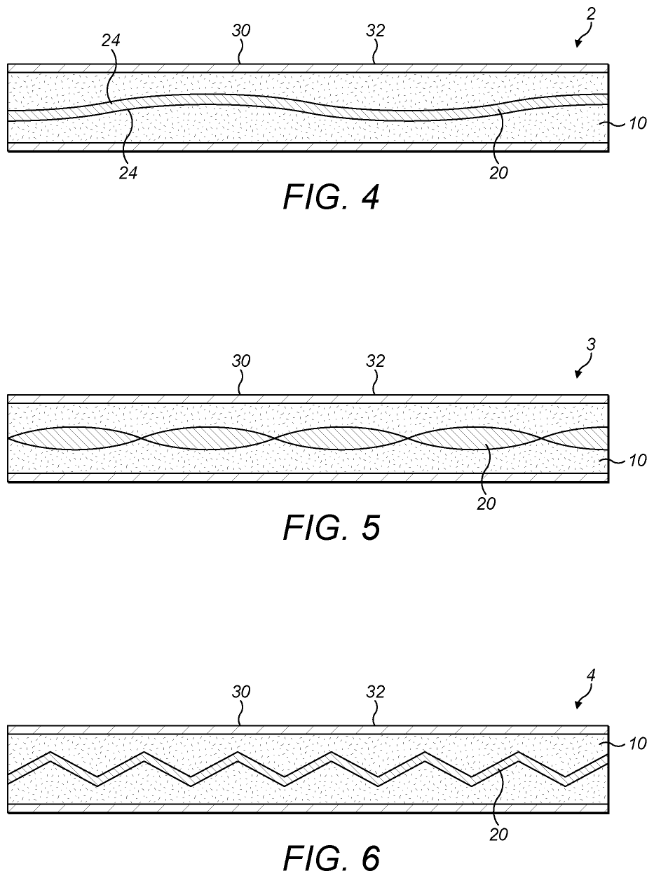

In some embodiments, the cover 30 may comprise a mass of thermal insulation. The thermal insulation may comprise one or more materials selected from the group consisting of: aerogel, vacuum insulation, wadding, fleece, non-woven material, non-woven fleece, woven material, knitted material, nylon, foam, polystyrene, polyester, polyester filament, polypropylene, a blend of polyester and polypropylene, cellulose acetate, paper or card, and corrugated material such as corrugated paper or card. The thermal insulation may additionally or alternatively comprise an air gap. Such thermal insulation can help prevent heat loss to components of the apparatus, and provide more efficient heating of the smokable material within the cover 30. In some embodiments, the insulation may have a thickness of up to one millimeter, such as up to 0.5 millimeters.

Whereas in this embodiment the elongate member 20 is planar or substantially planar, in other embodiments the elongate member 20 may be non-planar. For example, referring to FIGS. 4 to 6 there are shown schematic cross-sectional views of respective examples of other articles according to embodiments of the invention. The articles 2, 3, 4 of these embodiments are identical to the article 1 of FIGS. 1 to 3 except for the form of the elongate member 20. Any of the above-described possible variations to the article 1 of FIGS. 1 to 3 may be made to the articles 2, 3, 4 of FIGS. 4, 5 and 6 to form separate respective embodiments.

In the embodiment of FIG. 4, the elongate member 20 follows a wavelike or wavy path. The path may be a sinusoidal path. The elongate member 20 can still be considered a strip or ribbon, but the two major surfaces 24 of the strip or ribbon alternate along the length of the elongate member 20 between being concavely curved and being convexly curved. In its broadest sense, the elongate member 20 can be considered to follow a longitudinal axis that is coincident with the longitudinal axis of the article 2.

In the embodiment of FIG. 5, the elongate member 20 is twisted. In this embodiment, the elongate member 20 can be considered to be twisted about a longitudinal axis that is coincident with the longitudinal axis of the article 3. The elongate member 20 can still be considered a strip or ribbon, but the two major surfaces of the strip or ribbon are curved.

In the embodiment of FIG. 6, the elongate member 20 is corrugated. In this embodiment, the elongate member 20 can be considered to follow a longitudinal axis that is coincident with the longitudinal axis of the article 4. The elongate member 20 can still be considered a strip or ribbon, but the two major surfaces of the strip or ribbon are non-planar.

The non-planar shapes of the elongate members 20 of the articles 2, 3, 4 of FIGS. 4 to 6 may help air passing through the articles 2, 3, 4 to pick up the volatilized material created when the smokable material 10 is heated. Non-planar shapes can provide a tortuous path for air to follow, creating turbulence in the air and causing better heat transfer from the heating material to the smokable material 10. The non-planar shapes can also increase the surface area of the elongate member 20 per unit length of the elongate member 20. This can result in greater or improved Joule heating of the elongate member 20, and thus greater or improved heating of the smokable material 10. Non-planar elongate members 20 of other embodiments may have shapes other than those discussed above. For example, in some embodiments the elongate member 20 may be helical, a spiral shape, comprise a plate or strip or ribbon having protrusions thereon and/or indentations therein, comprise a mesh, comprise expanded metal, or have a non-uniform non-planar shape.

In some embodiments, a first portion 21 of the elongate member 20 may be more susceptible to eddy currents being induced therein by penetration with a varying magnetic field than a second portion 22 of the elongate member 20. FIG. 7 shows an example of such an arrangement. Although the article 5 of FIG. 7 has an elongate member 20 that is shaped like that of the article 1 of FIGS. 1 to 3, in other embodiments comprising such first and second portions 21, 22 of different susceptibility, the elongate member 20 may be shaped like those of the articles 2, 3, 4 of FIGS. 4 to 6, respectively.

The first portion 21 of the elongate member 20 may be more susceptible as a result of the first portion 21 of the elongate member 20 being made of a first material, the second portion 22 of the elongate member 20 being made of a different second material, and the first material being of a higher susceptibility to eddy currents being induced therein than the second material. For example, one of the first and second portions 21, 22 may be made of iron, and the other of the first and second portions 21, 22 may be made of graphite. Alternatively or additionally, the first portion 21 of the elongate member 20 may be more susceptible as a result of the first portion 21 of the elongate member 20 having a different thickness to the second portion 22 of the elongate member 20.

While in FIG. 7 the first and second portions 21, 22 are located adjacent each other in the longitudinal direction of the article 5 or of the elongate member 20, in other embodiments this need not be the case. For example, in some embodiments the first and second portions 21, 22 may be disposed adjacent each other in a direction perpendicular to the longitudinal direction of the article 5 or of the elongate member 20.

Such varying susceptibility of the elongate member 20 to eddy currents being induced therein can help achieve progressive heating of the smokable material 10, and thereby progressive generation of vapor. For example, the higher susceptibility portion 21 may be able to heat a first region of the smokable material 10 relatively quickly to initialize volatilization of at least one component of the smokable material 10 and formation of vapor in the first region of the smokable material 10. The lower susceptibility portion 22 may be able to heat a second region of the smokable material 10 relatively slowly to initialize volatilization of at least one component of the smokable material 10 and formation of vapor in the second region of the smokable material 10. Accordingly, vapor is able to be formed relatively rapidly for inhalation by a user, and vapor can continue to be formed thereafter for subsequent inhalation by the user even after the first region of the smokable material 10 may have ceased generating vapor. The first region of the smokable material 10 may cease generating the vapor when it becomes exhausted of volatilizable components of the smokable material 10.

In other embodiments, all of the elongate member 20 may be equally, or substantially equally, susceptible to eddy currents being induced therein by penetration with a varying magnetic field. In some embodiments, the elongate member 20 may not be susceptible to such eddy currents. In such embodiments, the heating material may be a magnetic material that is non-electrically-conductive, and thus may be heatable by the magnetic hysteresis process discussed above.

In some embodiments, the article may comprise a plurality of elongate members 20 within the mass of smokable material 10, wherein each of the elongate members 20 comprises heating material that is heatable by penetration with a varying magnetic field. At least one of the plurality of elongate members 20 may be more susceptible to eddy currents being induced therein by penetration with a varying magnetic field than at least one of the other of the plurality of elongate members 20. This may be effected by the elongate members 20 being made of different heating materials and/or having different thicknesses, for example, as discussed above. Again, such varying susceptibility of the elongate members 20 can help achieve progressive heating of the smokable material 10, and thereby progressive generation of vapor, in a manner corresponding to that described above.

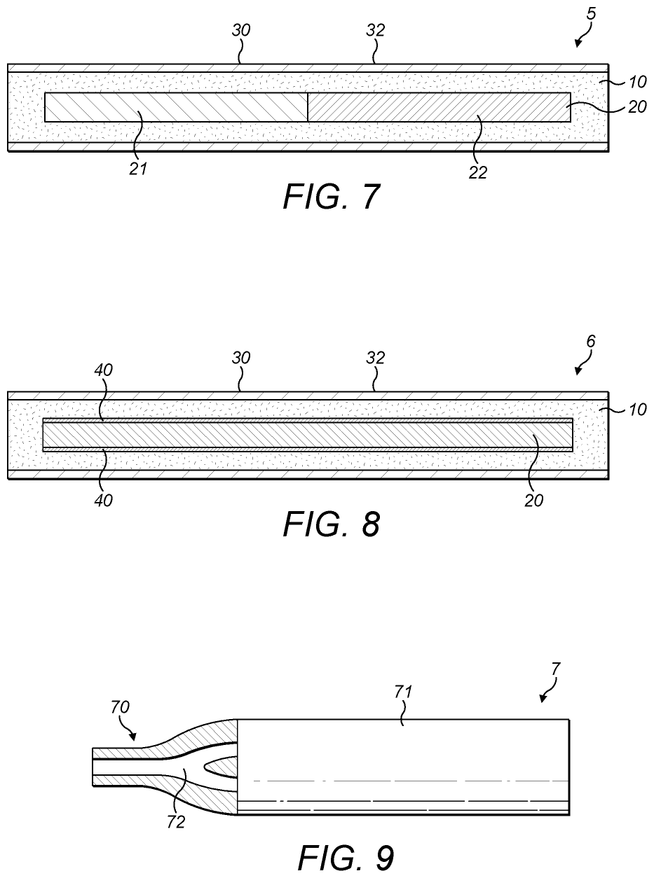

In some embodiments, the article may comprise a catalytic material 40 on at least a portion of the elongate member 20. FIG. 8 shows an example of such an arrangement. Although the article 6 of FIG. 8 has an elongate member 20 that is shaped like that of the article 1 of FIGS. 1 to 3, in other embodiments in which such a catalytic material is provided, the elongate member 20 may be shaped like those of the articles 2, 3, 4 of FIGS. 4 to 6, respectively. The catalytic material 40 may take the form of a coating on the elongate member 20. The catalytic material 40 may be provided on all surface(s) of the elongate member 20, or on only some of the surface(s) of the elongate member 20.

The provision of such a catalytic material 40 on the elongate member 20 means that, in use, the article 6 may have a heated, chemically active surface. In use, the catalytic material 40 may act to convert, or increase the rate of conversion of, a potential irritant to something that is less of an irritant. In use, the catalytic material 40 may act to convert, or increase the rate of conversion of formic acid to methanol, for example. In other embodiments, the catalytic material 40 may act to convert, or increase the rate of conversion of, other chemicals, such as acetylene to ethane by hydrogenation, or ammonia to nitrogen and hydrogen. The catalytic material may additionally or alternatively act to react, or increase the rate of reaction of, carbon monoxide and water vapor to form carbon dioxide and hydrogen (the water-gas shift reaction, or WGSR).

In some embodiments, the article comprises a mouthpiece defining a passageway that is in fluid communication with the mass of smokable material 10. Referring to FIG. 9, there is shown a schematic partial cross-sectional view of an example of an article 7 according to an embodiment of the invention. The section of the article 7 numbered 71 could comprise any of the constructions shown in FIGS. 1 to 8 or any of the variants thereof discussed above. The mouthpiece 70 and passageway 72 thereof are shown connected to the construction with the passageway 72 aligned so as to be in fluid communication with the mass of smokable material 10 of the construction. The mouthpiece 70 may be made of any suitable material, such as a plastics material, cardboard, or rubber.

In use, when the smokable material 10 is heated by the heated elongate member 20, volatilized components of the smokable material 10 can be readily inhaled by a user. In embodiments in which the article is a consumable article, once all or substantially all of the volatilizable component(s) of the smokable material 10 in the article has/have been spent, the user may dispose of the mouthpiece together with the rest of the article. This can be more hygienic than using the same mouthpiece with multiple articles, can help ensure that the mouthpiece is correctly aligned with the smokable material, and presents a user with a clean, fresh mouthpiece each time they wish to use another article.

The mouthpiece 70, when provided, may comprise or be impregnated with a flavorant. The flavorant may be arranged so as to be picked up by heated vapor as the vapor passes through the passageway 72 of the mouthpiece 70 in use.

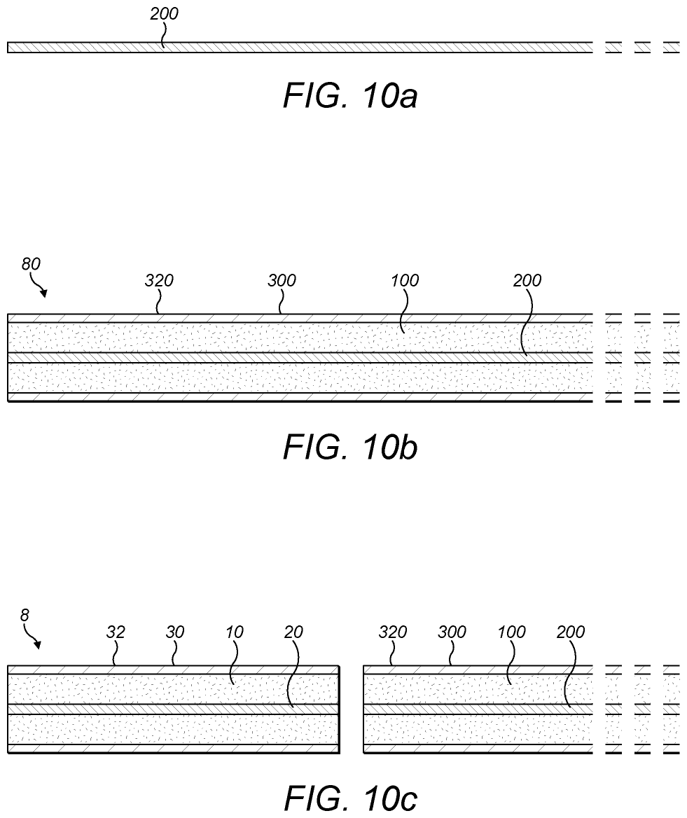

Referring to FIGS. 10a to 10c, there will now be described an example of a method according to an embodiment of the invention of manufacturing an article for use with apparatus for heating smokable material to volatilize at least one component of the smokable material. The method may be used to manufacture any of the above-described articles 1 to 6 of FIGS. 1 to 8.

Referring to FIG. 10a, the method comprises providing an elongate element 200 comprising heating material that is heatable by penetration with a varying magnetic field. In this embodiment, a section of the elongate element 200 ultimately will form the elongate member 20 of the article 8. However, the elongate element 200 is longer than the final elongate member 20. The section of the elongate element 200 may take any form, such as the form of one of the elongate members 20 discussed above, i.e. planar, non-planar, wavy, twisted, corrugated, helical, spiral-shaped, or non-uniform non-planar shaped.

Referring to FIG. 10b, the elongate element 200 is located within smokable material 100. A portion of the smokable material 100 ultimately will form the mass of smokable material 10 of the article 8. The provision of the elongate element 200 and the locating thereof in the smokable material 100 forms an elongate assembly 80 comprising the elongate element 200 within the smokable material 100. Moreover, in this embodiment, a covering 300 is provided around the smokable material 100 and the elongate element 200. A section of the covering 300 ultimately will form the cover 30 of the article 8. In this embodiment, the covering 300 comprises a wrapper 320 and forms part of the elongate assembly 80. In embodiments in which the article 8 to be made does not have a cover 30, the provision of the covering 300 around the smokable material 100 and the elongate element 200 may be omitted.

In some embodiments, the creation of the assembly 80 shown in FIG. 10b may comprise moving the smokable material 100 along a path, and feeding the elongate element 200 into the smokable material 100 from a source, such as a spool, via an outlet, so as to entrain the elongate element 200 in the smokable material 100 as the smokable material moves along the path. The feeding of the elongate element 200 may be effected by, for example, using a mechanical or electromechanical delivery device such as feed rollers, or a conveyor. Such a mechanical or electromechanical delivery device may have its delivery speed adjusted so as to meter the elongate element 200 into the smokable material 100 at an appropriate rate, for instance on the basis of the speed of the smokable material 100 past the outlet. The combination of the elongate element 200 and smokable material 100 may pass through a tongue of a garniture, where it is wrapped with the covering 300 to form the assembly 80.

Referring to FIG. 10c, the elongate assembly 80 is then cut at a predetermined longitudinal position along the elongate assembly 80 to form the article 8. In the article 8 so formed, the elongate member 20 extends to opposite longitudinal ends of the mass of smokable material 10. In an embodiment in which the article 8 is to have a mouthpiece as described above, the mouthpiece could be connected to the elongate assembly 80 before, during or after the assembly 80 is so cut. The connection of the mouthpiece to the assembly 80 may be effected by adhesive or by the mouthpiece clamping the assembly 80, for example.

In other embodiments, the formation of the article may not require cutting of an elongate assembly. In some such embodiments, the elongate element 200 may be the elongate member 20 of the article being manufactured, the smokable material 100 may itself form the mass of smokable material 10 of the article being manufactured, and the covering 300 may be the cover 30 of the article being manufactured. In some such embodiments, the elongate member 20 may not extend to opposite longitudinal ends of the mass of smokable material 10.

In some embodiments, which may be respective variations to the embodiments discussed above, the cover 30 may comprise heating material that is heatable by penetration with a varying magnetic field. For example, in some embodiments, the cover 30 may consist entirely, or substantially entirely, of the heating material. In some embodiments, the cover 30 may comprise a closed circuit of the heating material that encircles the smokable material 10. The heating material of the cover 30 may comprise any one or more of the materials discussed above for the heating material of the elongate member 20.

Each of the above-described articles 1, 2, 3, 4, 5, 6, 7, 8 and described variants thereof may be used with an apparatus for heating the smokable material 10 to volatilize at least one component of the smokable material 10. The apparatus may be to heat the smokable material 10 to volatilize the at least one component of the smokable material 10 without burning the smokable material 10. Any one of the article(s) 1, 2, 3, 4, 5, 6, 7, 8 and such apparatus may be provided together as a system. The system may take the form of a kit, in which the article 1, 2, 3, 4, 5, 6, 7, 8 is separate from the apparatus. Alternatively, the system may take the form of an assembly, in which the article 1, 2, 3, 4, 5, 6, 7, 8 is combined with the apparatus.

The apparatus may comprise a magnetic field generator for generating a varying magnetic field for heating the heating material of the elongate member 20 of the article 1, 2, 3, 4, 5, 6, 7, 8. Such a magnetic field generator may comprise an electrical power source, coil, a device for passing a varying electrical current, such as an alternating current, through the coil, a controller, and a user interface for user-operation of the controller. The electrical power source may be a rechargeable battery, a non-rechargeable battery, a connection to a mains electricity supply, or the like.

The coil may take any suitable form, such as a helical coil of electrically-conductive material, such as copper. The magnetic field generator may comprise a magnetically permeable core around which the coil is wound, to concentrate the magnetic flux produced by the coil and make a more powerful magnetic field. The magnetically permeable core may be made of iron, for example. In some embodiments, the magnetically permeable core may extend only partially along the length of the coil, so as to concentrate the magnetic flux only in certain regions.

The device for passing a varying electrical current through the coil may be electrically connected between the electrical power source and the coil. The controller may be electrically connected to the electrical power source, and be communicatively connected to the device to control the device, so as to control the supply of electrical power from the electrical power source to the coil. In some embodiments, the controller may comprise an integrated circuit (IC), such as an IC on a printed circuit board (PCB). In other embodiments, the controller may take a different form. In some embodiments, the apparatus may have a single electrical or electronic component comprising the device and the controller. The controller may be operated by user-operation of the user interface, which may comprise a push-button, a toggle switch, a dial, a touchscreen, or the like. Operation of the user interface by a user may cause the controller to cause the device to apply an alternating electric current across the coil, so as to cause the coil to generate an alternating magnetic field.

The apparatus may have a recess or other interface for receiving the article 1, 2, 3, 4, 5, 6, 7, 8 and the coil may be positioned relative to the recess or interface so that the varying or alternating magnetic field produced by the coil in use penetrates the recess or interface at a location corresponding to the heating material of the article 1, 2, 3, 4, 5, 6, 7, 8 when the article 1, 2, 3, 4, 5, 6, 7, 8 is in the recess or cooperating with the interface. When the heating material of the article 1, 2, 3, 4, 5, 6, 7, 8 is an electrically-conductive material, this may cause the generation of one or more eddy currents in the heating material of the elongate member 20 of the article 1, 2, 3, 4, 5, 6, 7, 8. The flow of eddy currents against the electrical resistance of the heating material of the elongate member 20 of the article 1, 2, 3, 4, 5, 6, 7, 8 causes the heating material of the elongate member 20 of the article 1, 2, 3, 4, 5, 6, 7, 8 to be heated by Joule heating. When the heating material of the elongate member 20 of the article 1, 2, 3, 4, 5, 6, 7, 8 is a magnetic material, the orientation of magnetic dipoles in the heating material changes with the changing applied magnetic field, which causes heat to be generated in the heating material of the elongate member 20 of the article 1, 2, 3, 4, 5, 6, 7, 8 by magnetic hysteresis heating.

The apparatus may have a mechanism for compressing the article 1, 2, 3, 4, 5, 6, 7, 8 when the article 1, 2, 3, 4, 5, 6, 7, 8 is inserted in the recess or cooperating with the interface. Such compression of the article 1, 2, 3, 4, 5, 6, 7, 8 can compress the smokable material 10, so as to increase the thermal conductivity of the smokable material 10. In other words, compression of the smokable material 10 can provide for higher heat transfer through the article 1, 2, 3, 4, 5, 6, 7, 8.

The apparatus may have a temperature sensor for sensing a temperature of the recess, interface, or article 1, 2, 3, 4, 5, 6, 7, 8 in use. The temperature sensor may be communicatively connected to the controller, so that the controller is able to monitor the temperature. In some embodiments, the temperature sensor may be arranged to take an optical temperature measurement of the recess, interface or article. In some embodiments, the article 1, 2, 3, 4, 5, 6, 7, 8 may comprise a temperature detector, such as a resistance temperature detector (RTD), for detecting a temperature of the article 1, 2, 3, 4, 5, 6, 7, 8. The article 1, 2, 3, 4, 5, 6, 7, 8 may further comprise one or more terminals connected, such as electrically-connected, to the temperature detector. The terminal(s) may be for making connection, such as electrical connection, with a temperature monitor of the apparatus when the article 1, 2, 3, 4, 5, 6, 7, 8 is in the recess or cooperating with the interface. The controller may comprise the temperature monitor. The temperature monitor of the apparatus may thus be able to determine a temperature of the article 1, 2, 3, 4, 5, 6, 7, 8 during use of the article 1, 2, 3, 4, 5, 6, 7, 8 with the apparatus.

In some embodiments, by providing that the heating material of the article 1, 2, 3, 4, 5, 6, 7, 8 has a suitable resistance, the response of the heating material to a change in temperature could be sufficient to give information regarding temperature inside the article 1, 2, 3, 4, 5, 6, 7, 8. The temperature sensor of the apparatus may then comprise a probe for analyzing the heating material.

On the basis of one or more signals received from the temperature sensor or temperature detector, the controller may cause the device to adjust a characteristic of the varying or alternating current passed through the coil as necessary, in order to ensure that the temperature remains within a predetermined temperature range. The characteristic may be, for example, amplitude or frequency. Within the predetermined temperature range, in use the smokable material 10 within an article 1, 2, 3, 4, 5, 6, 7, 8 inserted in the recess or cooperating with the interface may be heated sufficiently to volatilize at least one component of the smokable material 10 without combusting the smokable material 10. In some embodiments, the temperature range is about 50° C. to about 250° C., such as between about 50° C. and about 150° C., between about 50° C. and about 120° C., between about 50° C. and about 100° C., between about 50° C. and about 80° C., or between about 60° C. and about 70° C. In some embodiments, the temperature range is between about 170° C. and about 220° C. In other embodiments, the temperature range may be other than this range. The apparatus may have a delivery device for delivering the volatilized component(s) of the smokable material 10 to a user.

The apparatus may define an air inlet that fluidly connects the recess or interface with an exterior of the apparatus. A user may be able to inhale the volatilized component(s) of the smokable material by drawing the volatilized component(s) through a channel, such as a channel of a mouthpiece of the apparatus. As the volatilized component(s) are removed from the article 1, 2, 3, 4, 5, 6, 7, 8, air may be drawn into the recess or interface via the air inlet of the apparatus.

The apparatus may provide haptic feedback to a user. The feedback could indicate that heating of the susceptor is taking place, or be triggered by a timer to indicate that greater than a predetermined proportion of the original quantity of volatilizable component(s) of the smokable material 10 in the article 1, 2, 3, 4, 5, 6, 7, 8 has/have been spent, or the like. The haptic feedback could be created by interaction of the susceptor with the coil (i.e. magnetic response), by interaction of an electrically-conductive element with the coil, by rotating an unbalanced motor, by repeatedly applying and removing a current across a piezoelectric element, or the like.

The apparatus may comprise more than one coil. The plurality of coils could be operated to provide progressive heating of the smokable material 10 in an article 1, 2, 3, 4, 5, 6, 7, 8, and thereby progressive generation of vapor. For example, one coil may be able to heat a first region of the heating material relatively quickly to initialize volatilization of at least one component of the smokable material 10 and formation of vapor in a first region of the smokable material 10. Another coil may be able to heat a second region of the heating material relatively slowly to initialize volatilization of at least one component of the smokable material 10 and formation of vapor in a second region of the smokable material 10. Accordingly, vapor is able to be formed relatively rapidly for inhalation by a user, and vapor can continue to be formed thereafter for subsequent inhalation by the user even after the first region of the smokable material 10 may have ceased generating vapor. The initially-unheated second region of smokable material 10 could act as a filter, to reduce the temperature of created vapor or make the created vapor mild, during heating of the first region of smokable material 10.

In some embodiments, the heating material of the elongate member or cover may comprise discontinuities or holes therein. Such discontinuities or holes may act as thermal breaks to control the degree to which different regions of the smokable material are heated in use. Areas of the heating material with discontinuities or holes therein may be heated to a lesser extent that areas without discontinuities or holes. This may help progressive heating of the smokable material, and thus progressive generation of vapor, to be achieved.

In each of the above described embodiments, the smokable material 10 comprises tobacco. However, in respective variations to each of these embodiments, the smokable material 10 may consist of tobacco, may consist substantially entirely of tobacco, may comprise tobacco and smokable material other than tobacco, may comprise smokable material other than tobacco, or may be free of tobacco. In some embodiments, the smokable material 10 may comprise a vapor or aerosol forming agent or a humectant, such as glycerol, propylene glycol, triactein, or diethylene glycol.

An article embodying the present invention may be a cartridge or a capsule, for example.

In each of the above described embodiments, the article 1, 2, 3, 4, 5, 6, 7, 8 is a consumable article. Once all, or substantially all, of the volatilizable component(s) of the smokable material 10 in the article 1, 2, 3, 4, 5, 6, 7, 8 has/have been spent, the user may remove the article 1, 2, 3, 4, 5, 6, 7, 8 from the apparatus and dispose of the article 1, 2, 3, 4, 5, 6, 7, 8. The user may subsequently re-use the apparatus with another of the articles 1, 2, 3, 4, 5, 6, 7, 8. However, in other respective embodiments, the article 1, 2, 3, 4, 5, 6, 7, 8 may be non-consumable, and the apparatus and the article 1, 2, 3, 4, 5, 6, 7, 8 may be disposed of together once the volatilizable component(s) of the smokable material 10 has/have been spent.

In some embodiments, the apparatus discussed above is sold, supplied or otherwise provided separately from the articles 1, 2, 3, 4, 5, 6, 7, 8 with which the apparatus is usable. However, in some embodiments, the apparatus and one or more of the articles 1, 2, 3, 4, 5, 6, 7, 8 may be provided together as a system, such as a kit or an assembly, possibly with additional components, such as cleaning utensils.

Embodiments of the disclosure could be implemented in a system comprising any one of the articles discussed herein, and any one of the apparatuses discussed herein, wherein the apparatus itself further has heating material, such as in a susceptor, for heating by penetration with the varying magnetic field generated by the magnetic field generator. Heat generated in the heating material of the apparatus itself could be transferred to the article to further heat the smokable material therein.

In order to address various issues and advance the art, the entirety of this disclosure shows by way of illustration and example various embodiments in which the claimed invention may be practiced and which provide for superior articles for use with apparatus for heating smokable material to volatilize at least one component of the smokable material, superior methods of manufacturing such articles, and superior systems comprising such articles and such apparatus. The advantages and features of the disclosure are of a representative sample of embodiments only, and are not exhaustive and/or exclusive. They are presented only to assist in understanding and teach the claimed and otherwise disclosed features. It is to be understood that advantages, embodiments, examples, functions, features, structures and/or other aspects of the disclosure are not to be considered limitations on the disclosure as defined by the claims or limitations on equivalents to the claims, and that other embodiments may be utilized and modifications may be made without departing from the scope and/or spirit of the disclosure. Various embodiments may suitably comprise, consist of, or consist in essence of, various combinations of the disclosed elements, components, features, parts, steps, means, etc. The disclosure may include other inventions not presently claimed, but which may be claimed in future.

1. An article for use with an apparatus for heating smokable material to volatilize at least one component of the smokable material, the article comprising:
a mass of smokable material;
an elongate member disposed within the mass of smokable material, the elongate member including heater material that is heatable by penetration with a varying magnetic field; and
a cover disposed around the mass of smokable material and the elongate member, wherein the cover comprises a wrapper that is wrapped around the smokable material so that free ends of the wrapper overlap each other, and wherein the wrapper comprises adhesive that adheres the overlapped free ends of the wrapper to each other,
wherein the article has a circular cross-section and the elongate member is substantially free of discontinuities.

2. The article of claim 1, wherein the elongate member is disposed within the mass of smokable material such that the elongate member extends from a first longitudinal end of the mass of smokable material to a second, opposite longitudinal end of the mass of smokable material.

3. The article of claim 1, wherein the elongate member consists substantially entirely of the heater material.

4. The article of claim 1, wherein the heater material includes one or more materials selected from the group consisting of: an electrically-conductive material, a magnetic material, and a non-magnetic material.

5. The article of claim 1, wherein the heater material comprises a metal or a metal alloy.

6. The article of claim 1, wherein the heater material comprises one or more materials selected from the group consisting of: aluminum, gold, iron, nickel, cobalt, conductive carbon, graphite, plain-carbon steel, stainless steel, ferritic stainless steel, copper, and bronze.

7. The article of claim 1, wherein the heater material is in contact with the smokable material.

8. The article of claim 1, wherein the elongate member has two opposing major surfaces joined by two minor surfaces.

9. The article of claim 1, wherein the elongate member has a length and a cross-section perpendicular to the length, wherein the cross-section has a width and a depth, and wherein the length of the elongate member is greater than the width of the cross-section, and the width of the cross-section is greater than the depth of the cross-section.

10. The article of claim 1, wherein the elongate member is substantially planar.

11. The article of claim 1, wherein the elongate member is non-planar.

12. The article of claim 1, wherein a first portion of the elongate member is more susceptible to eddy currents induced therein via penetration with a varying magnetic field than a second portion of the elongate member.

13. The article of claim 1, further comprising a catalytic material on at least a portion of the elongate member.

14. The article of claim 1, wherein the article is elongate, and the elongate member is disposed such that the elongate member extends along a longitudinal axis that is substantially aligned with a longitudinal axis of the article.

15. The article of claim 1, further comprising a mouthpiece that defines a passageway that is in fluid communication with the mass of smokable material.

16. The article of claim 1, wherein the cover includes heater material that is heatable by penetration with a varying magnetic field.

17. The material of claim 1, wherein the smokable material includes at least one of tobacco or one or more humectants.

18. A method of manufacturing an article for use with an apparatus configured to heat smokable material to volatilize at least one component of the smokable material, the method comprising:
providing an elongate member including heater material that is heatable by penetration with a varying magnetic field;
locating the elongate member within a mass of smokable material; and
providing a cover around the smokable material and the elongate member, wherein the cover comprises a wrapper that is wrapped around the smokable material so that free ends of the wrapper overlap each other and adhesive that adheres the overlapped ends of the wrapper to each other,
wherein the article has a circular cross-section and the elongate member is substantially free of discontinuities.

19. A system comprising:
an apparatus configured to heat smokable material to volatilize at least one component of the smokable material; and
the article according to claim 1.

20. The system of claim 19, wherein the apparatus includes an interface configured to cooperate with the article, and a magnetic field generator configured to generate a varying magnetic field that penetrates the heater material when the article cooperates with the interface.
